(19) United States
(12) Patent Application Publication
(10) Pub. No.: US 2008/0162855 A1
(43) Pub. Date: Jul. 3, 2008

(54) Memory Command Issue Rate Controller

(76) Inventor: Tessil Thomas, Bangalore (IN)

Correspondence Address: CAVEN & AGHEVLI;c/o INTELLEVATE, LLC, P.O. BOX 52050, MINNEAPOLIS, MN, 55402, US

(21) Appl. No.: 11/854,386

(22) Filed: Sep. 12, 2007

(30) Foreign Application Priority Data
Dec. 29, 2006 (IN) 2827/DEL/2006

(51) Int. Cl. G06F 12/00

(52) U.S. Cl. 711/167; 711/E12.001

(57) ABSTRACT

Method and apparatus to reduce latency of command while maintaining the thermal level of a memory in a safe value is disclosed. A memory request with or without a command to a memory may be scheduled by a memory request scheduler. If the memory request has the command to the memory then a memory command credit counter for that memory may be decreased. If the memory request does not have the command to the memory then the memory command credit counter for that memory may be increased. The increased credits of the memory command credit counter may be used to execute the memory requests frequently and the latency of the command may thus be reduced.

### BACKGROUND

This application claims priority to pending Indian Patent Application No. 2728/DEL/2006 filed on Dec. 29, 2006.

A memory controller may issue commands to a memory in order to read data from the memory or write data into the memory. The memory may, for example, comprise a dynamic random access memory (DRAM), double data rate (DDR) and other similar memory. The memory may be in the form of a module, such as, a dual inline memory module (DIMM). The commands issuance may have to be throttled or stopped, periodically, to maintain thermal levels of the memory to a safe value. By throttling issuance of the commands, idle cycles may be generated on the memory bus, if the idle cycles are not available naturally. The duration of active and throttled phases may be modulated to maintain the thermal levels within a certain range of the safe value. The commands that arrive during the active phase may be serviced or executed during the active phase itself. However, the commands arrive during the throttled phase may have to wait until the next active phase is resumed. Therefore, commands that arrive during the throttled phase may be accumulated and may have a higher latency.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a computer system.

FIG. 2 illustrates an embodiment of the memory command scheduler coupled with the throttling unit of FIG. 1

FIG. 3 illustrates an embodiment of a memory request trace having frequent active and throttled phases.

FIG. 4 illustrates an embodiment of the process of reducing command latency while maintaining thermal levels below a specified value.

### DETAILED DESCRIPTION

In the following detailed description, numerous specific details are described in order to provide a thorough understanding of the invention. However the present invention may be practiced without these specific details. In other instances, well known methods, procedures, components and circuits have not been described in detail so as not to obscure the present invention. Further, exemplary sizes, values and ranges may be given, but it should not be understood that the present invention is limited to these specific example.

References in the specification to “one embodiment”, “an embodiment”, or “an exemplary embodiment”, indicate that the embodiment described may include a particular feature, structure, or characteristic, but not every embodiment necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

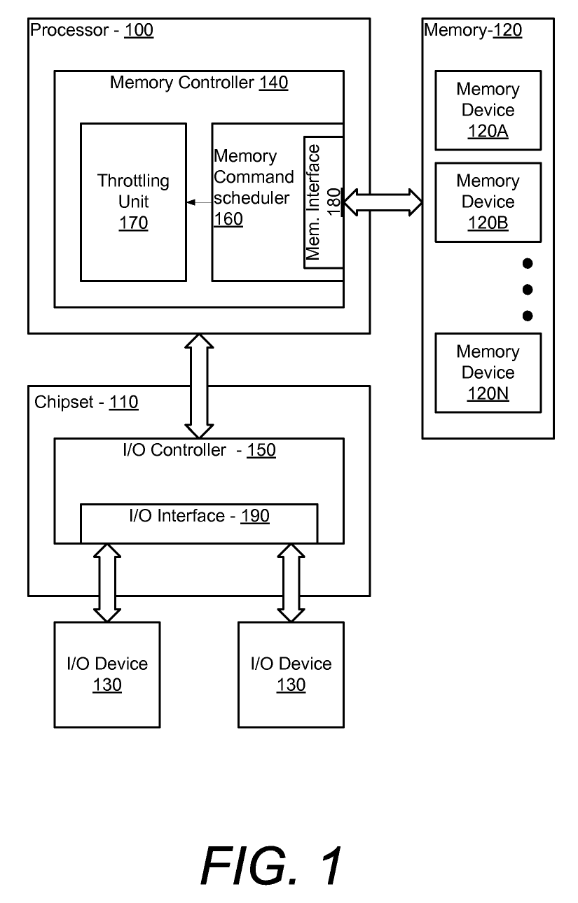

Referring to FIG. 1, an embodiment of a computer system is shown. The computer system may include a processor 100, a chipset 110, a memory 120, and I/O (input/output) devices 130. As depicted, the processor 100 may be coupled with the chipset 110. The memory 120 may be coupled with the processor 100. The I/O devices 130 may be coupled with the chipset 110 via an I/O bus such as PCI (Peripheral Component Interconnect) buses, PCI Express buses, USB (Universal Serial Bus) buses, and SATA (Serial Advanced Technology Attachment) buses.

As depicted, the processor 100 may comprise a memory controller (MC) 140. The memory controller 140 may comprise a memory command scheduler 160 and a throttling unit 170. The memory command scheduler 160 may include a memory interface 180. In one embodiment, the memory interface 180 may include a DDR DIMM bus. In another embodiment, the memory interface 180 may include a fully buffered DIMM bus (FBDIMM) link. The processor 100 may execute instructions stored in the memory 120 to perform various tasks and to control the overall operation of the computer system. In one embodiment, the processor 100 may generate a memory request to a memory device. The memory request may, for example, include a FBDIMM link layer frame or a DIMM bus command. In one embodiment, the memory 120 may include a plurality of memory devices 120A, 120B to 120N. The memory devices 120A to 120N, in one embodiment, may, for example, include dual inline memory modules (DIMMs) with multiple ranks.

The memory controller 140 may receive a read or a write request and may generate a memory request to a memory device. In one embodiment, the memory controller 140 may read or write data from or to the memory devices 120A, 120B and 120N in response to commands received from the processor 100 and/or I/O devices 130. The throttling unit 170 may determine whether the memory request includes a command to a particular memory device, such as, 120A, 120B, or 120N. If the memory request includes a command to the memory device 120A, the throttling unit 170 may send a credit decrease signal to credit management logic for the memory device 120A. If the memory request does not include a command to the memory device 120A, the throttling unit 170 may send credit increase signal to the credit management logic for the memory device 120A. In one embodiment, the memory request may include a command to any memory device, such as, the memory device 120N. The throttling unit 170 may then send credit decrease or increase signal for the memory 120N.

In another embodiment, the memory controller 140 may be provided within the chipset 110 and a memory interface may be provided to couple the memory controller 140 with the memory devices 120A, 120B, and 120N. In one embodiment, the memory controller 140 may read and/or write data to memory devices 120A, 120B and 120N in response to commands received from the processor 100 and/or I/O devices 130.

As depicted, the chipset 110 may comprise an I/O controller 150. The I/O controller 150, according to an embodiment, may comprise an I/O interface 190. The I/O interface 190 may, for example, comprise a PCI Express interface to interface the I/O devices 130 with the I/O controller 150, thus permitting data transfers between the processor 100 and the I/O devices 130 and between the memory devices 120A to 120N. The I/O devices 130 may comprise hard disk drives, keyboards, mice, CD (compact disc) drives, DVD (digital video discs) drives, printers, and scanners.

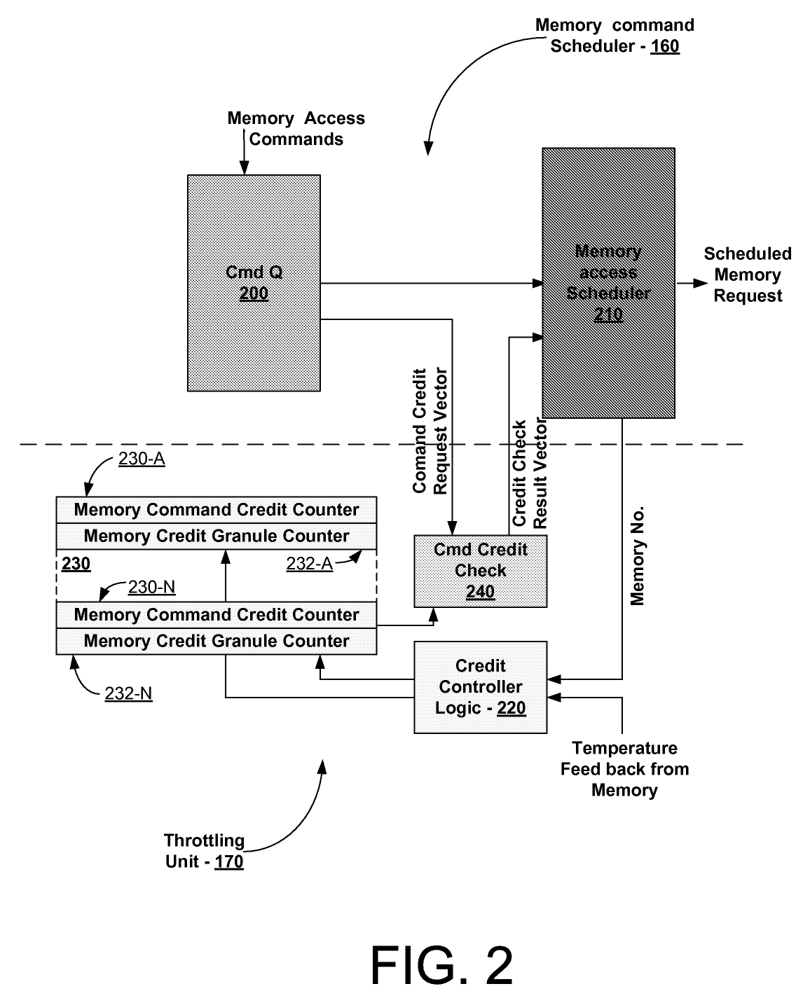

Referring to FIG. 2, an embodiment of a memory command scheduler coupled with a throttling unit is illustrated. As depicted, the memory command scheduler 160 may comprise a command queue (Q) 200 coupled to a memory request scheduler 210. In one embodiment, the memory request scheduler 210 may comprise a DRAM access scheduler to schedule a memory request to a memory device 120A. In one embodiment, the memory request may include a DIMM bus request. The throttling unit 170 may comprise a credit controller logic 220, a memory credit management logic 230, and a command credit check logic 240. The credit controller logic 220 may be coupled to the memory credit management logic 230. The memory credit management logic 230 may be coupled to the command credit check logic 240. The command credit check logic 240 may be coupled to the memory request scheduler 210. The memory request scheduler 210 may be coupled to the credit controller logic 220. The memory command Q 200 may also be coupled to the command credit check logic 240. In one embodiment, the memory credit management logic 230 may comprise a plurality of memory command credit counters 230-A to 230-N and memory credit granule counters 232-A to 232-N for the memory devices 120A to 120N, respectively.

The command Q 200 may receive memory commands, for example, DRAM memory read or write commands and may arrange the memory commands in a queue in order to expose the memory commands to the memory request scheduler 210. In one embodiment, the command Q 200 may also expose the memory commands to the command credit check logic 240. The memory request scheduler 210 may generate a memory request to a memory device 120A, 120B, or 120N based on the command received from the command Q 200. The memory scheduler 210 may send out the memory request on a memory bus, such as, a DRAM DIMM bus or a FBDIMM link.

In one embodiment, the credit counter logic 220 may, also examine outgoing memory request to determine whether the memory request includes a memory command to a memory device 120A or 120B to 120N. For example. If the credit counter logic 220 determines that the memory request includes a memory command to the memory device 120A, then a signal may be sent to the memory credit management logic 230 to decrease the memory command credit counter 230-A for the memory device 120A to adjust the memory command credit counter 230-A. The memory command credit counter 230-A may be decreased by an amount equal to a number of DRAM clock cycles consumed by the memory command. For example, a RAS (row address strobe) command may cause 1 DRAM cycle activity. In such a situation, the memory command credit counter 230-A for the memory 120A may be decremented by 1. The memory credit management logic 230 may expose the current value of the memory command credit counters 230-A to 230-N for the memory devices 120A to 120N to the command credit check logic 240. The command credit check logic 240 may, for every entry in the command Q 200, compare the credit required to be scheduled with an amount of credit available for a certain memory device 120A or 120B to 120N. If the credit is available, then the bit corresponding to that entry may be set in a credit check result vector. The memory request scheduler 210 may scheduled memory access command on the memory bus based on the command credit check logic 240.

In one embodiment, if the credit counter logic 220 determines that the memory request does not include a command to the memory device 120A, then a signal may be sent to the memory credit management logic 230 to increase memory credit granule counter 232-A for the memory device 120A by 1. The memory command credit counter 230-A may be incremented every time the memory credit granule counter 232-A expires. The expiry value for the memory credit granule counter 320A may depend on the programmed memory bus duty cycle value. In one embodiment, the increment amount for the memory command credit counter 230-A may be determined by a desired memory bus duty cycle. The duty cycle for the memory command may be programmable. In one embodiment, the duty cycle may comprise 75% active or ON period for the DRAM memory command and 25% idle period or OFF period. In such a situation, the memory credit granule counter 232-A may expire as soon as its value reaches 1 and each memory credit granule counter 232-A expiry event may increment the memory command credit counter 230-A by 3. In another embodiment, a duty cycle of 60% active and 40% idle period may be required. In such a situation, the memory credit granule counter 232-A may expire as soon as its value reaches 4 and each memory credit granule counter 232-A expiry event may increment the memory command credit counter 230-A by 6. In one embodiment, the memory commands credits may be used to execute memory commands later.

In one embodiment, any duty cycle resulting in an integer increment value may be permitted. The memory credit management logic 230 may, for example, use a saturating arithmetic. Thus, when the memory command credit counter 230-A to 230-N reaches a maximum or minimum value possible for its size in terms of number of bits, the memory command credit counter 230-A to 230-N may remain stuck at that value. In one embodiment, the number of memory command credit counters 230-A to 230-N and memory credit granule counters 232-A to 232-N, used in the memory credit management logic 230 may depend on the number of memory devices 120A, 120B . . . 120N, provided in the memory.

In one embodiment, the duty cycle for the memory command may be increased or decreased based on the temperature feedback received from a FBDIMM type of memory. In one embodiment, the variation in the duty cycle may be programmable based on the temperature value read from a DDR3 types of memory device. If the temperature increases, the duration of the active phase may be decreased and if the temperature decreases, the duration of the active phase may be increased.

In one embodiment, when the computer system boots, the memory credit counter unit 230 may start with a programmed initial credit value. In one embodiment, the computer system may start with a very high duty cycle and allow the temperature feedback to automatically adjust the duty cycle to an optimal level. The time interval of temperature feedback, based upon the duty cycle, may depend on thermal time constant of the DIMMs. In one embodiment, credit checking may be done for each memory command, based on the memory command and the activity cycles that memory command produces, which may be computed based on the following equation:

If (DIMMX credit counter—activity cycle for the command to DIMMX)>0, then issue the command.

In one embodiment, if the temperature feedback may be provided on a per rank basis, then the duty cycle based throttling may be provided on per rank basis instead of per DIMM basis. In one embodiment each DIMM may include two ranks.

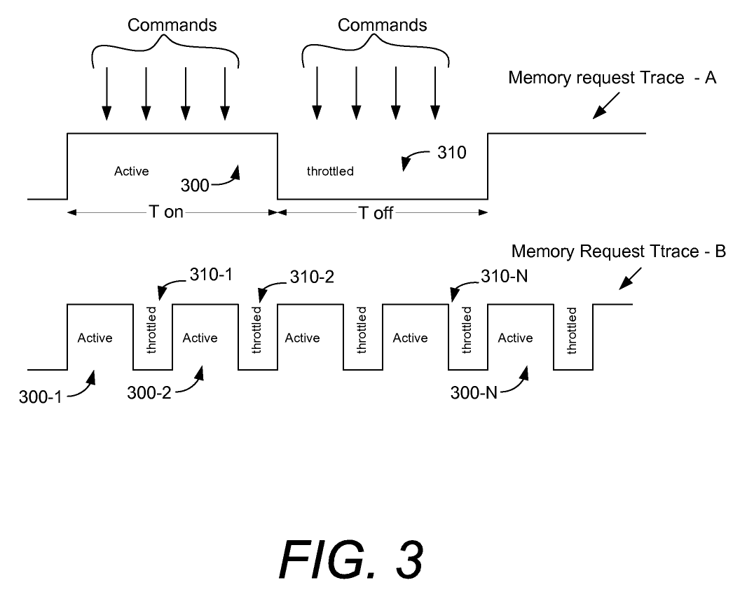

Referring to FIG. 3, an embodiment of a memory request trace is illustrated. The memory request trace may, for example, include a DRAM bus access trace. As depicted, the memory request trace-A may comprise an active phase 300 and a throttled phase 310 of a time duration Tₒₙ and T_{off}, respectively. In one embodiment, the duration of Tₒₙ and T_{off} may be based on a specific value provided by the memory technology of the memory devices 120A to 120N. For example, the specified value may indicate the maximum value of Tₒₙ and a minimum value of T_{off} that may be maintained to keep the thermal levels within the allowable range. For example, four commands may arrive during the active phase 300 and all the four commands may be executed during the active phase 300. Also, four commands may arrive during the throttled phase 300 and these four commands may not be executed until the next active phase 300 is resumed after the time duration T_{off} of the throttled phase 310.

In one embodiment and as depicted, a memory request trace-B may comprise a plurality of active phases 300-1, 300-2 to 300-N and throttled phases 310-1, 310-2 to 310-N. In one embodiment, the memory bus access trace—B may be generated such that the time duration of all the active phases 300-1, 300-2 to 300-N may not be greater than the time duration Tₒₙ of the active phase 300. The time duration of all the throttled phases 310-1, 310-2 to 310-N may not be lesser than the time duration T_{off} of the throttled phase 300B.

In one embodiment, the commands arriving during the first active phase 300-1 may be executed during the active phase 300-1 itself. However, the commands arrive during the first throttled phase 310-1 may be serviced during the second active phase 300-2. The latency of the commands arrived during throttled phase 310-2 may be less due to less number of the commands accumulated in the throttled phase 310-2. In one embodiment, the total time duration of the plurality of frequent active phases 300-1 to 300-N may equal Tₒₙ and total time duration of throttled phases 310-1 to 310-N may equal T_{off}. Thus, the memory commands arrived during the active phase 300-1 and throttled phase 310-1 may be executed frequently and therefore with reduced latency.

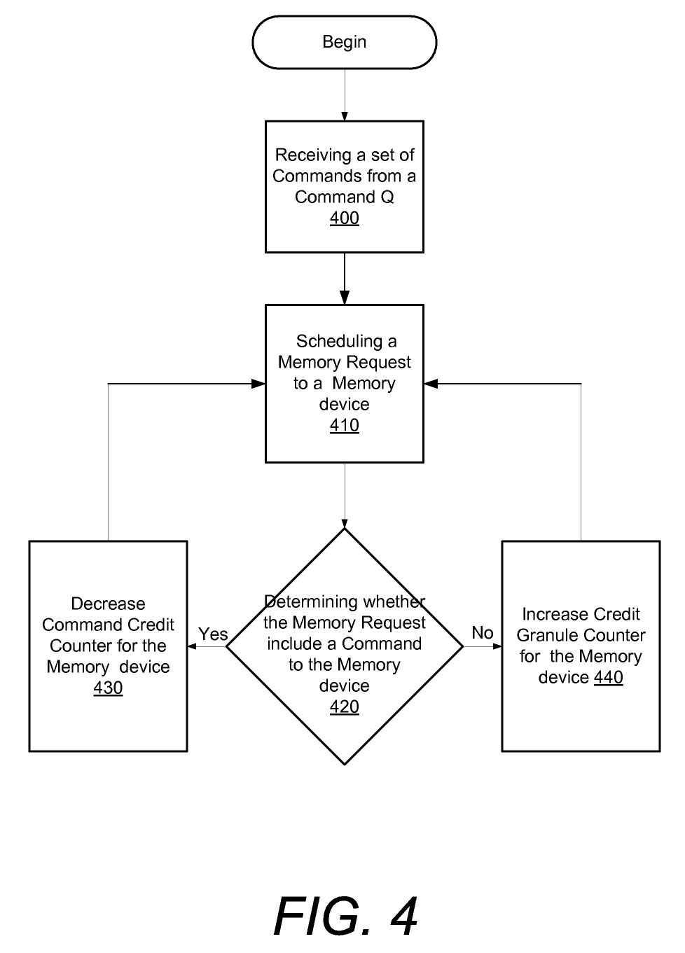

Referring now to FIG. 4, an embodiment of the process of reducing latency of commands while maintaining the thermal level within a specified value is illustrated. As depicted, in block 400, the memory request scheduler may receive a set of memory commands from a memory command queue which may have passed the credit check test available to schedule a memory request.

In block 410, the memory scheduler may schedule a memory request to a certain memory device. The memory scheduler may send the scheduled memory request.

In block 420, a credit controller logic may determine whether the memory request include a memory command to the memory device. If the credit controller logic determines that the memory request includes a command to that memory device, the credit controller logic may generate a signal to decrease the memory command credit counter for that memory device.

In block 430, the memory credit management logic may, upon receiving signals to decrease the memory command credit counter of that memory device may decrease the memory command credit counter by a number equal to the number of cycles consumed by the command on the memory bus for that memory command being sent out.

In one embodiment, if the credit counter logic determines that the memory request does not include a command to that memory device, the credit controller logic may generate a signal to increase the memory credit granule counter for that memory device.

In block 440, the memory credit management logic may, upon receiving signals to increase the memory credit granule counter of that memory, increase the memory credit granule counter of that memory by 1, and the memory command credit counter by a number determined by a desired duty cycle number, if the memory credit granule counter expires.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. A method to decrease a latency of a command comprising:
receiving a command at a memory scheduler from a command queue;
scheduling a memory request to a memory device;
determining a presence of the command in the memory request; and
adjusting a memory command credit counter for the memory device based on the command issued to the memory device to reduce the latency of the command while maintaining a thermal level of the memory device at a safe value.

2. The method of claim 1, wherein the scheduling comprises
generating the memory request to the memory device; and
sending the memory request to the memory device, upon receiving a credit check result vector from a command credit check logic.

3. The method of claim 1, wherein the memory request includes a command to the memory device.

4. The method of claim 3, wherein the memory credit counter is adjusted by decreasing the memory command credit counter of the memory device, based on a number of cycles consumed by the command on a memory bus.

5. The method of claim 1, wherein the memory command credit counter is adjusted by increasing the memory command credit counter by a memory bus duty cycle based on expiry of a memory credit granule counter.

6. An apparatus to decrease latency of a command comprising:
a memory command scheduler to schedule a memory request; and
a throttling unit to adjust a memory command credit counter for a memory device to execute a command to reduce a latency of the command while maintaining a thermal level of the memory device in a safe value.

7. The apparatus of claim 6, wherein the memory command scheduler comprises a command queue to receive the command and arrange the command in a queue to expose the command to a memory request scheduler.

8. An apparatus of claim 6 wherein the throttling unit comprises:
a credit controller logic coupled to the memory request scheduler, wherein the credit controller logic is to determine whether the memory request has a command to a memory device;
a memory credit management logic coupled to the credit controller logic; and
a command credit check logic coupled to the memory credit management logic, wherein the command credit check logic is to send a credit check result vector to the memory command scheduler to schedule the memory request.

9. The apparatus of claim 7, wherein the memory request scheduler schedules a memory request and sends out the memory request with the command to the memory device.

10. The apparatus of claim 7, wherein the memory request scheduler schedules a memory request and sends out the memory request without the command to the memory device.

11. The apparatus of claim 8, wherein the memory credit management logic comprises a memory command credit counter for each of the memory devices.

12. The apparatus of claim 11, wherein the memory credit management logic comprises a memory credit granule counter for each of the memory devices.

13. A system comprising
a memory device,
a chipset to control an input-output signal to be transmitted to a computer system,
an input-output device, and
a processor to schedule a memory request to the memory device and to adjust a memory command credit counter for the memory device based on the command issued to the memory device to reduce the latency of the command while maintaining a thermal level of the memory device at a safe value.

14. The system of claim 13, wherein the processor comprises a memory controller.

15. The system of claim 14, wherein the memory controller generates the memory request with a command to the memory device.

16. The system of claim 14, wherein the memory controller generates the memory request without the command to the memory device.

17. The system of claim 14, further comprising a throttling unit to decrease a memory command credit counter for the memory device, based on a number of cycles consumed by the command on a memory bus.

18. The system of claim 17, further comprising a throttling unit to increase the memory command credit counter for the memory by a memory bus duty cycle based on expiry of a memory credit granule counter.

19. The system of claim 18, wherein the throttling unit increases a credit granule counter for the memory device by one, if there is no memory request on the bus to the memory device.
